(19) United States
(12) Patent Application Publication
(10) Pub. No.: US 2023/0055652 A1
(43) Pub. Date: Feb. 23, 2023

(54) WATER-SOLUBLE METAL WORKING FLUID COMPOSITION AND METHOD FOR USING SAME

(71) Applicants: IDEMITSU KOSAN CO.,LTD., Chiyoda-ku (JP); IDEMITSU LUBE (CHINA) CO., LTD., TEDA Tianjin (CN)

(72) Inventors: Yuan ZHANG, TEDA (CN); Kenro NOGUCHI, TEDA (CN); Keiji ASADA, Chiyoda-ku (JP); Hideaki HATTORI, Chiyoda-ku (JP)

(73) Assignees: IDEMITSU KOSAN CO.,LTD., Chiyoda-ku (JP); IDEMITSU LUBE (CHINA) CO., LTD., TEDA Tianjin (CN)

(21) Appl. No.: 17/758,928

(22) PCT Filed: Jan. 15, 2021
(86) PCT No.: PCT/CN2021/072020

§ 371 Date: Aug. 23, 2022

(30) Foreign Application Priority Data
Jan. 16, 2020 (JP) 202010047740.6

(51) Int. Cl. C10M 105/26; C10M 169/04; C10M 173/00

(52) U.S. Cl. CPC C10M 105/26; C10M 169/044; C10M 173/00; C10M 2207/125; C10M 2215/042

(57) ABSTRACT

A water-soluble metalworking fluid composition and a method of using the same. The water-soluble metalworking fluid composition has the components (A), (B), and (C), where (A) is a fatty acid having a carbon atom number of 9-11, (B) is an unsaturated fatty acid having a carbon atom number of 16-22, and (C) is a polymeric fatty acid having an acid value of 10-200 mgKOH/g. (A) is 1-20 mass %, (B) is 30-60 mass %, and (C) is 35-55 mass %, based on the total amount of the components (A), (B) and (C). The water-soluble metalworking fluid composition maintains the workability while improving the mechanical fouling.

### TECHNICAL FIELD

The present invention relates to a water-soluble metalworking fluid composition and a method of using the same. In particular, the present invention relates to a water-soluble metalworking fluid composition, which can be suitable for cutting machining or grinding machining and improve the mechanical fouling while maintaining the workability, and a method of using the same.

### BACKGROUND TECHNOLOGY

In the field of the metalworking such as cutting machining and grinding machining, a metalworking oil is used for the purpose of improving the working efficiency, suppressing the friction between a material to be machined and a tool for machining the material to be machined, prolonging the life of the tool, removing the cutting scraps, and the like. The metalworking oil includes an oil (water-insoluble) mainly composed of an oil such as mineral oil, animal and vegetable oil, or synthetic oil, and an oil (water-soluble) imparted with water solubility by blending a compound having the surface activity with an oil. In recent years, an oil imparted with water solubility (referred to as the water-soluble metalworking oil) has been used due to the considerations such as the effective use of resources and the prevention of fire.

In patent document 1, it is recorded that the finer cutting scraps together with the highly viscous rust inhibitor component, as fouling, adhere to the material to be cut and the machine tool. In patent document 1, it is disclosed that a hydroxyaliphatic carboxylic acid having a carbon atom number of 2-8 is used to impart the effect of the fouling prevention (paragraph 0014).

### Prior Art Documents

[Patent document 1] JP2011079956A

### SUMMARY OF THE INVENTION

### The Problem to be Solved by the Invention

The present inventors discovered for the first time that, in the metalworking oil, when the amount of fatty acid or hydroxy fatty acid is high, a scum is likely to be generated. The reason for this is, for example, that the aforementioned excessive fatty acid forms a salt with an amine contained in the working fluid to dissolve in water, and react with Ca ions and Mg ions in water to generate the scum.

An object of the present invention relates to a water-soluble metalworking fluid composition that maintains the workability while improving the mechanical fouling and a method of using the same. In particular, it is also likely to improve the scum that causes mechanical fouling and be able to maintain the workability by blending the following specific components (A), (B), and (C) at a specific blending ratio, which is a feature of the present invention, even if being free of a hydroxy aliphatic carboxylic acid having a carbon atom number of 2-8.

### Solutions for Solving the Problem

[1]. A water-soluble metalworking fluid composition, which is characterized by containing the following components (A), (B), and (C),

the component (A) is a fatty acid having a carbon atom number of 9-11,

the component (B) is a component containing an unsaturated fatty acid having a carbon atom number of 16-22,

the component (C) is a polymeric fatty acid having an acid value of 10-200 mgKOH/g,

the component (A) comprises 1-20 mass %, based on the total amount of the component (A), the component (B), and the component (C),

the component (B) comprises 30-60 mass %, based on the total amount of the component (A), the component (B), and the component (C),

the component (C) comprises 35-55 mass %, based on the total amount of the component (A), the component (B), and the component (C).

[2]. The water-soluble metalworking fluid composition according to the above-mentioned [1], which is characterized by containing no hydroxy aliphatic carboxylic acid having a carbon atom number of 2-8.

[3]. The water-soluble metalworking fluid composition according to the above-mentioned [1] or [2], which is characterized in that (acid value×blending amount) of the component (A)/(acid value×blending amount) of the component (B) is 0.01-2, wherein the blending amount of the component (A) and the blending amount of the component (B) are the blending amount of each component based on the total amount of the water-soluble metalworking fluid composition respectively.

[4]. The water-soluble metalworking fluid composition according to any of the above-mentioned [1] to [3], which is characterized in that the ratio of the blending amount of the component (A)/the blending amount of the component (B) on a mass basis is 0.01-1, wherein the blending amount of the component (A) and the blending amount of the component (B) are the blending amount of each component based on the total amount of the water-soluble metalworking fluid composition respectively.

[5]. The water-soluble metalworking fluid composition according to any of the above-mentioned [1] to [4], which is characterized in that the total content of the component (A), the component (B), and the component (C) in the water-soluble metalworking fluid composition is 7 mass % or more based on the total amount of the water-soluble metalworking fluid composition.

[6]. The water-soluble metalworking fluid composition according to any of the above-mentioned [1] to [5], which is characterized in that the fatty acid as the constituting unit of the polymeric fatty acid of the component (C) is a hydroxy fatty acid.

[7]. The water-soluble metalworking fluid composition according to any of the above-mentioned [1] to [6], which is characterized in that the component (C) has a weight-average molecular weight of 400-4000.

[8]. The water-soluble metalworking fluid composition according to any of the above-mentioned [1] to [7], which is characterized by further comprising an amine compound as the component (D).

[9]. The water-soluble metalworking fluid composition according to any of the above-mentioned [1] to [8], which is characterized by being used for punching machining, cutting machining, or grinding machining.

[10]. The water-soluble metalworking fluid composition according to any of the above-mentioned [1] to [9], which is characterized in that the blending amount of the component (A) is 0.05-4 mass % based on the total amount of the water-soluble metalworking fluid composition.

[11]. The water-soluble metalworking fluid composition according to any of the above-mentioned [1] to [10], which is characterized in that the blending amount of the component (B) is 3-10 mass % based on the total amount of the water-soluble metalworking fluid composition.

[12]. The water-soluble metalworking fluid composition according to any of the above-mentioned [1] to [11], which is characterized in that the blending amount of the component (C) is 4-16 mass % based on the total amount of the water-soluble metalworking fluid composition.

[13]. The water-soluble metalworking fluid composition according to any of the above-mentioned [1] to [12], which is characterized by further comprising at least one of corrosion inhibitors, discoloration inhibitors, surfactants, metal deactivators, rust inhibitors, defoaming agents, and bactericides.

[14]. A method of using a water-soluble metalworking fluid composition, wherein the water-soluble metalworking fluid composition according to any of [1]-[13] is diluted with water so that the concentration of the metalworking fluid composition is 3 vol % or more for use in the metalworking.

[15]. A metalworking method, wherein a metal material is processed by using the water-soluble metalworking fluid composition according to any of the above-mentioned [1]-[13].

[16]. A process for preparing a water-soluble metalworking fluid composition, wherein the following components (A), (B), and (C) are blended to form the following blending amounts,

the component (A) is a fatty acid having a carbon atom number of 9-11,

the component (B) is a component containing an unsaturated fatty acid having a carbon atom number of 16-22,

the component (C) is a polymeric fatty acid having an acid value of 10-200 mgKOH/g,

the component (A) comprises 1-20 mass %, based on the total amount of the component (A), the component (B), and the component (C),

the component (B) comprises 30-60 mass %, based on the total amount of the component (A), the component (B), and the component (C),

the component (C) comprises 35-55 mass %, based on the total amount of the component (A), the component (B), and the component (C).

[17]. A water-soluble metalworking fluid composition obtained by the process for preparing a water-soluble metalworking fluid composition according to the above-mentioned [16].

### Effect of Invention

According to the present invention, it is also likely to improve the scum (that causes mechanical fouling) and be able to maintain the workability by blending the specific components (A), (B), and (C) at a blending ratio of the specific components, even if being free of a hydroxy aliphatic carboxylic acid having a carbon atom number of 2-8.

### DESCRIPTION OF THE DRAWINGS

FIG. 1 is a diagram showing the result of the evaluation of the detergency of the water-soluble metalworking fluid composition of Example 1.

FIG. 2 is a diagram showing the result of the evaluation of the detergency of the water-soluble metalworking fluid composition of Comparative Example 1.

FIG. 3 is a diagram showing the result of the evaluation of the detergency of the water-soluble metalworking fluid composition of Example 2.

FIG. 4 is a diagram showing the result of the evaluation of the detergency of the water-soluble metalworking fluid composition of Comparative Example 2.

FIG. 5 is a diagram showing the result of the evaluation of the detergency of the water-soluble metalworking fluid composition of Example 3.

FIG. 6 is a diagram showing the result of the evaluation of the detergency of the water-soluble metalworking fluid composition of Comparative Example 3.

### DETAILED DESCRIPTION

Various technical solutions in various embodiments disclosed in this specification can be combined arbitrarily. Various technical features in various technical solutions disclosed in this specification can be combined arbitrarily.

The upper limits and the lower limits of the numerical ranges disclosed in this specification can be arbitrarily combined. For example, when “A-B” and “C-D” are described, ranges “A-D” and “C-B” are also included in the present invention. Further, the numerical range “the lower limit to the upper limit” described in this specification means the lower limit or more but the upper limit or less. Unless otherwise specified, in this specification, the blending amount, the content, “%”, and the like are based on the mass.

[Water-Soluble Metalworking Fluid Composition]

The water-soluble metalworking fluid composition of the present invention (hereinafter also simply referred to as “composition” or “stock solution”) contains the following component (A), component (B), and component (C).

It should be noted that the total content of the component (A), the component (B), and the component (C) in the water-soluble metalworking fluid composition of the present invention is 7 mass % or more, preferably 10 mass % or more, more preferably 14 mass % or more, based on the total amount of the composition. On the other hand, the total content of the component (A), the component (B), and the component (C) in the water-soluble metalworking fluid composition of the present invention is 30 mass % or less, preferably 26 mass % or less, more preferably 22 mass % or less, based on the total amount of the composition.

In one embodiment of the present invention, the total content of the component (A), the component (B), and the component (C) in the water-soluble metalworking fluid composition of the present invention is 15 mass % or 21.1 mass %, based on the total amount of the composition.

<Component (A)>

The component (A) in the water-soluble metalworking fluid composition of the present invention is a fatty acid having a carbon atom number of 9-11. The component (A) is associated with mechanical fouling.

The above-mentioned fatty acid having a carbon atom number of 9-11 of the component (A) is preferably a fatty acid having a carbon atom number of 10. In addition, as the above-mentioned fatty acid having a carbon atom number of 9-11 of the component (A), a straight chain fatty acid having a carbon atom number of 9-11 or branched-chain fatty acid having a carbon atom number of 9-11 can be enumerated. It should be noted that a branched-chain fatty acid having a carbon atom number of 9-11 is preferable from the viewpoint of the emulsification stability and the reduction of the scum.

The above-mentioned fatty acid having a carbon atom number of 9-11 of the component (A) can be a saturated fatty acid, or an unsaturated fatty acid, preferably a saturated fatty acid.

As the above-mentioned fatty acid having a carbon atom number of 9-11 of the component (A), for example, n-nonanoic acid, iso-nonanoic acid, n-decanoic acid, iso-decanoic acid, neo-decanoic acid, n-undecylic acid, iso-undecylic acid and the like can be enumerated.

One of these components (A) may be used individually, or two or more of them may be used arbitrarily in combination.

The component (A) in the water-soluble metalworking fluid composition of the present invention comprises 1-20 mass %, preferably 3-18 mass %, more preferably 5-15 mass %, in particular preferably 7-11 mass %, based on the total amount of the component (A), the component (B), and the component (C). When the above-mentioned blending amount of the component (A) is less than 1 mass %, the stability of the stock solution and the stability of the diluted solution deteriorate. When the above-mentioned blending amount of the component (A) exceeds 20 mass %, mechanical fouling will be generated. In one embodiment of the present invention, the component (A) in the water-soluble metalworking fluid composition of the present invention comprises about 8.05 mass %, about 8.06 mass %, or 10 mass %, based on the total amount of the component (A), the component (B), and the component (C).

The blending amount of the component (A) in the water-soluble metalworking fluid composition of the present invention is 0.05-4.0 mass %, preferably 0.1-3.5 mass %, more preferably 0.5-2.5 mass %, particularly preferably 1-2 mass %, based on the total amount of the composition. When the above-mentioned blending amount of the component (A) is less than 0.05 mass %, the stability of the stock solution and the stability of the diluted solution deteriorate. When the above-mentioned blending amount of the component (A) exceeds 4.0 mass %, mechanical fouling will be generated.

In one embodiment of the present invention, the blending amount of the component (A) in the water-soluble metalworking fluid composition of the present invention is 1.5 mass % or 1.7 mass %, based on the total amount of the composition.

From the viewpoint of the emulsification stability, the acid value of the component (A) in the water-soluble metalworking fluid composition of the present invention is 200 mgKOH/g-500 mgKOH/g, preferably 250 mgKOH/g-400 mgKOH/g, more preferably 300 mgKOH/g-350 mgKOH/g, particularly preferably 310 mgKOH/g-330 mgKOH/g.

In one embodiment of the present invention, the acid value of the component (A) in the water-soluble metalworking fluid composition of the present invention is 320 mgKOH/g.

It should be noted that the acid value is a value [mgKOH/g] measured according to ASTM D664.

<Component (B)>

The component (B) in the water-soluble metalworking fluid composition of the present invention contains an unsaturated fatty acid having a carbon atom number of 16-22. The unsaturated fatty acid has an iodine value of 50-200, preferably 100-150, more preferably 120-135. The iodine value is a value measured according to ASTM D 1959. Based on the total amount of the component (B), the unsaturated fatty acid comprises 50-100 mass %, preferably 60-95 mass %, more preferably 70-90 mass %.

In one embodiment of the present invention, based on the total amount of the component (B), the unsaturated fatty acid comprises 80 mass % or more. It should be noted that when an excessive amount of the saturated fatty acid having a carbon atom number of 16-22 is contained, it is prone to generate the scum, which is not good. When the component (B) is blended with the following component (C), the stability of the water-soluble metalworking fluid composition is maintained, and mechanical fouling is improved, while the workability of the water-soluble metalworking fluid composition is maintained in a well-balanced manner.

For the above-mentioned unsaturated fatty acid having a carbon atom number of 16-22 of the component (B), if the carbon atom number is less than 16, the emulsification stability of the water-soluble metalworking fluid composition deteriorates, and if the carbon atom number is higher than 22, the emulsification stability of the water-soluble metalworking fluid composition deteriorates, and there is a worry for the generation of mechanical fouling. In addition, the above-mentioned unsaturated fatty acid having a carbon atom number of 16-22 of the component (B) is preferably an unsaturated fatty acid having a carbon atom number of 18.

For the above-mentioned unsaturated fatty acid having a carbon atom number of 16-22 of the component (B), for example, palmitoleic acid, oleic acid, linoleic acid, linolenic acid, docosenoic acid, elaidic acid, erucic acid, and the like can be enumerated. The unsaturated fatty acid is preferably oleic acid and/or linoleic acid.

One of these components (B) may be used individually, or two or more of them may be used arbitrarily in combination.

In one embodiment of the present invention, the above-mentioned component (B) is a rice bran oil fatty acid containing 80 mass % or more of an unsaturated fatty acid having a carbon atom number of 18 (oleic acid: 45 mass % or more, linoleic acid: 35 mass % or more).

The component (B) in the water-soluble metalworking fluid composition of the present invention comprises 30-60 mass %, preferably 33-55 mass %, more preferably 36-50 mass %, particularly preferably 39-47 mass %, based on the total amount of the component (A), the component (B), and the component (C). When the above-mentioned blending amount of the component (B) is less than 30 mass %, the stock solution becomes unstable and the detergency deteriorates. When the above-mentioned blending amount of the component (B) exceeds 60 mass %, the stock solution becomes unstable.

In one embodiment of the present invention, the component (B) in the water-soluble metalworking fluid composition of the present invention comprises about 39.8 mass %, about 39.9 mass %, about 46.6 mass %, or about 46.7 mass %, based on the total amount of the component (A), the component (B), and the component (C).

The blending amount of the component (B) in the water-soluble metalworking fluid composition of the present invention is 3-10 mass %, preferably 4-9.5 mass %, more preferably 5-9 mass %, particularly preferably 6.5-8.5 mass %, based on the total amount of the composition. When the above-mentioned blending amount of the component (B) is less than 3 mass %, the stock solution becomes unstable and the detergency deteriorates. When the above-mentioned blending amount of the component (B) exceeds 10 mass %, the stock solution becomes unstable.

In one embodiment of the present invention, the blending amount of the component (B) in the water-soluble metalworking fluid composition of the present invention is 7 mass % or 8.4 mass %, based on the total amount of the composition.

From the viewpoint of the stock solution stability, the acid value of the component (B) in the water-soluble metalworking fluid composition of the present invention is 100 mgKOH/g-300 mgKOH/g, preferably 150 mgKOH/g-250 mgKOH/g, more preferably 175 mgKOH/g-225 mgKOH/g, particularly preferably 190 mgKOH/g-200 mgKOH/g. In one embodiment of the present invention, the acid value of the component (B) in the water-soluble metalworking fluid composition of the present invention is 197 mgKOH/g.

It should be noted that the acid value is a value [mgKOH/g] measured according to ASTM D664.

<Component (C)>

The component (C) in the water-soluble metalworking fluid composition of the present invention is a polymeric fatty acid having an acid value of 10 mgKOH/g-200 mgKOH/g.

The component (C) contributes to the workability of the water-soluble metalworking fluid composition.

The acid value of the above-mentioned component (C) is preferably 10 mgKOH/g-200 mgKOH/g, more preferably 20 mgKOH/g-100 mgKOH/g, particularly preferably 30 mgKOH/g-38 mgKOH/g, from the viewpoint of the emulsification stability and the workability. In one embodiment of the present invention, the acid value of the component (C) in the water-soluble metalworking fluid composition of the present invention is 35 mgKOH/g.

It should be noted that the acid value is a value [mgKOH/g] measured according to ASTM D664.

The component (C) in the water-soluble metalworking fluid composition of the present invention has a weight-average molecular weight (Mw) of 400-4000. The above-mentioned molecular weight is preferably 400-3000, more preferably 1000-2500, particularly preferably 1800-2000. When the above-mentioned molecular weight is less than 400, the workability decreases. When the above-mentioned molecular weight exceeds 4000, it is difficult to function as a polymeric fatty acid, and sometimes the emulsification stability deteriorates.

It should be noted that in this specification, for example, the weight-average molecular weight can be measured by using a gel permeation chromatography apparatus (made by Agilent company, “1260 Type HPLC”) under the following conditions through standard polystyrene conversion.

(Measurement Conditions)
Column: A column formed by successively connecting two “Shodex LF404”.
Column temperature: 35° C.
Developing solvent: chloroform
Flow rate: 0.3 mL/min.

The fatty acid constituting the polymeric fatty acid of the component (C) in the water-soluble metalworking fluid composition of the present invention (the fatty acid as a constituting unit of the polymeric fatty acid of the component (C)) is preferably a hydroxy fatty acid, more preferably a monohydroxy fatty acid. The above-mentioned fatty acid is preferably an unsaturated fatty acid.

The carbon atom number of the fatty acid constituting the polymeric fatty acid of the component (C) in the water-soluble metalworking fluid composition of the present invention is 8-30, preferably 9-24, more preferably 10-22, particularly preferably 16-20. In one embodiment of the present invention, the carbon atom number of the fatty acid constituting the component (C) in the water-soluble metalworking fluid composition of the present invention is 18.

As the fatty acid constituting the polymeric fatty acid of the component (C) in the water-soluble metalworking fluid composition of the present invention, for example, hydroxy nonanoic acid, hydroxy decanoic acid, hydroxy lauric acid, hydroxy myristic acid, hydroxy palmitic acid, hydroxy stearic acid, hydroxy arachidic acid, hydroxy behenic acid, ricinoleic acid, ricinoleic acid, hydroxy octadecenoic acid, hydroxy decanedioic acid, hydroxyoctyl decanedioic acid, norcaperatic acid, 2-hydroxy-1,2,3-nonadecane tricarboxylic acid, as dihydroxy monocarboxylic acid, 3,11-dihydroxyl tetradecanoic acid, dihydroxyl hexadecanoic acid, dihydroxyl stearic acid, dihydroxyl octadecenoic acid, dihydroxyl octadecadienoic acid, dihydroxyl dodecanedioic acid, dihydroxyl hexadecandioic acid, 9,10-dihydroxy octadecandioic acid, dihydroxy hexacosandioic acid, and the like can be enumerated. In addition, castor oil fatty acid and hydrogenated castor oil fatty acid obtained from natural oils and fats can also be used.

The polymerization degree of the component (C) in the water-soluble metalworking fluid composition of the present invention is 2-10, preferably 4-8, more preferably 5-7. When the polymerization degree is less than 2, the workability of the water-soluble metalworking fluid composition decreases, and when the polymerization degree exceeds 10, the emulsification stability of the water-soluble metalworking fluid composition deteriorates.

In one embodiment of the present invention, the polymerization degree of the component (C) in the water-soluble metalworking fluid composition of the present invention is 6.

In the present invention, the polymerization degree, that is, DP (degree of polymerization) is the number of monomer units in the macromolecule, polymer, or oligomer molecule.

In one embodiment of the present invention, the component (C) in the water-soluble metalworking fluid composition of the present invention is a polyricinoleic acid (having an acid value of 35 mgKOH/g, and a polymerization degree of 6).

One of these components (C) may be used individually, or two or more of them may be used arbitrarily in combination.

The polymeric fatty acid of the component (C) in the water-soluble metalworking fluid composition of the present invention can be obtained by reacting the above-mentioned fatty acid according to the conventional polymerization reaction, for example, in the absence of a catalyst or the presence of an appropriate catalyst at room temperature or under a heating condition.

The component (C) in the water-soluble metalworking fluid composition of the present invention comprises 30-60 mass %, preferably 34-58 mass %, more preferably 38-56 mass %, particularly preferably 43-53 mass %, based on the total amount of the component (A), the component (B), and the component (C). When the above-mentioned blending amount of the component (C) is less than 30 mass %, sometimes the workability decreases, and the stability of the stock solution deteriorates. When the above-mentioned blending amount of the component (C) exceeds 60 mass %, there is a worry that the emulsification stability decreases and the scum generation increases (the detergency decreases).

In one embodiment of the present invention, the component (C) in the water-soluble metalworking fluid composition of the present invention comprises about 43.3 mass %, about 43.4 mass %, about 52.1 mass % or about 52.2 mass %, based on the total amount of the component (A), the component (B), and the component (C).

The blending amount of the component (C) in the water-soluble metalworking fluid composition of the present invention is 4-16 mass %, preferably 4.5-14 mass %, more preferably 5.5-13 mass %, particularly preferably 6-12 mass %, based on the total amount of the composition. When the above-mentioned blending amount of the component (C) is less than 4 mass %, there is a worry that the stability of the stock solution deteriorates and the workability is inadequate. When the above-mentioned blending amount of the component (C) exceeds 16 mass %, there is a worry that the emulsification stability decreases and the scum generation increases (the detergency decreases).

In one embodiment of the present invention, the blending amount of the component (C) in the water-soluble metalworking fluid composition of the present invention is 6.5 mass % or 11 mass %, based on the total amount of the composition.

In the water-soluble metalworking fluid composition of the present invention, no hydroxyaliphatic carboxylic acid having a carbon atom number of 2-8 is contained. The hydroxyaliphatic carboxylic acid having a carbon atom number of 2-8 (for example, citric acid, malic acid, and the like) contributes to the detergency, but if too much, the corrosion generates, and therefore in the water-soluble metalworking fluid composition of the present invention, no hydroxyaliphatic carboxylic acid having a carbon atom number of 2-8 is contained.

<Ratio of Blending Amounts>

The acid value of each of the following components is the acid value described in the description of each of the above-mentioned components, and the blending amount of each of the following components is the blending amount of each component relative to the total amount of the composition described in the description of each of the above-mentioned components.

In the water-soluble metalworking fluid composition of the present invention, from the viewpoint of the emulsification stability and the detergency, (acid value-blending amount) of the above-mentioned component (A)/(acid value×blending amount) of the above-mentioned component (B) is 0.01-2, preferably 0.05-1.5, more preferably 0.1-1, particularly preferably 0.2-0.4.

In one embodiment of the present invention, in the water-soluble metalworking fluid composition of the present invention, (acid value×blending amount) of the above-mentioned component (A)/(acid value×blending amount) of the above-mentioned component (B) is 0.3287 or 0.3481.

In the water-soluble metalworking fluid composition of the present invention, from the viewpoint of the emulsification stability and the detergency, (acid value×blending amount) of the above-mentioned component (A)/(acid value×blending amount) of the above-mentioned component (C) is 0.1-4, preferably 0.5-3, more preferably 1.0-2.5, particularly preferably 1.4-2.2.

In one embodiment of the present invention, in the water-soluble metalworking fluid composition of the present invention, (acid value-blending amount) of the above-mentioned component (A)/(acid value×blending amount) of the above-mentioned component (C) is 1.4130 or 2.1099.

In the water-soluble metalworking fluid composition of the present invention, (acid value×blending amount) of the above-mentioned component (B)/(acid value×blending amount) of the above-mentioned component (C) is 0.1-20, preferably 1-15, more preferably 2-10, particularly preferably 4-6.5. When the above-mentioned ratio is less than 0.1, the stock solution is unstable. When the above-mentioned ratio exceeds 20, there is a worry that the stability of the stock solution deteriorates and the detergency deteriorates.

In one embodiment of the present invention, in the water-soluble metalworking fluid composition of the present invention, (acid value×blending amount) of the above-mentioned component (B)/(acid value×blending amount) of the above-mentioned component (C) is 4.2982 or 6.0615.

In the water-soluble metalworking fluid composition of the present invention, from the viewpoint of the emulsification stability and the detergency, the ratio of the blending amount of the component (A)/the blending amount of the component (B) on a mass basis is 0.01-1, preferably 0.05-0.75, more preferably 0.1-0.5, particularly preferably 0.15-0.25.

In one embodiment of the present invention, in the water-soluble metalworking fluid composition of the present invention, the ratio of the blending amount of the component (A)/the blending amount of the component (B) on a mass basis is 0.202 or 0.214.

In the water-soluble metalworking fluid composition of the present invention, the ratio of the blending amount of the component (A)/the blending amount of the component (C) on a mass basis is 0.01-0.5, preferably 0.05-0.4, more preferably 0.1-0.3, particularly preferably 0.15-0.25. When the above-mentioned ratio is less than 0.01, the stock solution is unstable. When the above-mentioned ratio exceeds 0.5, the stock solution is unstable.

In one embodiment of the present invention, in the water-soluble metalworking fluid composition of the present invention, the ratio of the blending amount of the component (A)/the blending amount of the component (C) on a mass basis is 0.155 or 0.231.

In the water-soluble metalworking fluid composition of the present invention, the ratio of the blending amount of the component (B)/the blending amount of the component (C) on a mass basis is 0.1-2.5, preferably 0.3-2, more preferably 0.5-1.5, particularly preferably is 0.7-1.1. When the above-mentioned ratio is less than 0.1, there is a worry that the detergency decreases and the emulsification stability deteriorates. When the above-mentioned ratio exceeds 2.5, there is a worry that the workability is inadequate and the defoaming capability deteriorates.

In one embodiment of the present invention, in the water-soluble metalworking fluid composition of the present invention, the ratio of the blending amount of the component (B)/the blending amount of the component (C) on a mass basis is 0.764 or 1.077.

<Component (D)>

The water-soluble metalworking fluid composition of the present invention may further contain an amine compound (hereinafter also referred to as component (D)).

As an amine compound, for example, an alkanolamine, an alkylamine, an alicyclic amine, an aromatic amine, and the like can be enumerated.

These amine compounds may be water-soluble or water-insoluble.

As the alkanolamine, for example, monoethanolamine, diethanolamine, N-methyldiethanolamine, triethanolamine, mono-isopropanolamine (1-amino-2-propanol), diisopropanolamine, triisopropanolamine, methyl diethanolamine, ethyldiethanolamine, butyldiethanolamine, cyclohexyldiethanolamine, lauryldiethanolamine, dimethylethanolamine, diethylethanolamine, dibutylethanolamine, dioctylethanolamine, octyldipropanolamine, stearyldipropanolamine, dibutylpropanolamine, dihexylpropanolamine, dilaurylpropanolamine, and the like can be enumerated. In addition, oleyldiethanolamine, xylyldiethanolamine, dioleylethanolamine, phenyldiethanolamine, benzyldiethanolamine, and tolyldipropanolamine can also be included as the amine compound.

As the alkylamine, methylamine, ethylamine, dimethylamine, diethylamide, methylethylamine, methylpropylamine, ethylene diamine, tetramethylene diamine, N-ethylethylene diamine, diethylene triamine, triethylene tetramine, tetraethylene pentamine, pentaethylene hexamine, and the like can be enumerated.

As the alicyclic amine, for example, dicyclohexyl amine, 1,4-diaminocyclohexane, 4,4′-diaminodicyclohexylmethane, 4,4′-diamino-3,3′-dimethyldicyclohexylmethane, N,N-dicyclohexylmethylamine, and the like can be enumerated.

As the aromatic amine, for example, benzylamine, dibenzylamine, and the like can be enumerated.

These amine compounds may be further mono- or multiple-substituted with an alkyl having a carbon atom number of 1-18, or a functional group having a ring structure such as cyclohexyl, and phenyl.

From the viewpoint of corrosion resistance, the component (D) is preferably at least one of N-methyldiethanolamine, triethanolamine, N,N-dicyclohexylmethylamine, dicyclohexyl amine, mono-isopropanolamine (1-amino-2-propanol), triisopropanolamine, and cyclohexyldiethanolamine.

One of these amine compounds may be used individually, or two or more of them may be used arbitrarily in combination.

From the viewpoint of the emulsification stability of the stock solution or the diluted solution, the blending amount of the component (D) in the water-soluble metalworking fluid composition of the present invention is 1-40 mass %, preferably 5-30 mass %, more preferably 10-20 mass %, particularly preferably 12-18 mass %, based on the total amount of the composition.

In one embodiment of the present invention, the blending amount of the component (D) in the water-soluble metalworking fluid composition of the present invention is 14.9 mass %, 15.3 mass %, or 15.7 mass %, based on the total amount of the composition.

<Other Components>

In the water-soluble metalworking fluid composition of the present invention, other optional components (additives and the like) may be further blended, provided that the effects of the present invention are not impaired.

As the additive, for example, corrosion inhibitors, discoloration inhibitors, surfactants, metal deactivators, rust inhibitors, defoaming agents, bactericides, and the like can be enumerated. One of these additives may be used individually, or two or more of them may be used arbitrarily in combination.

As the corrosion inhibitor, for example, benzotriazole compounds (for example, 1,2,3-benzotriazole and the like) and the like can be enumerated. One of these corrosion inhibitors may be used individually, or two or more of them may be used arbitrarily in combination. The blending amount is preferably about 0.1-10 mass % based on the total amount of the composition.

As the discoloration inhibitor, for example, phosphate ester-based corrosion inhibitors (for example, polyoxyethylene alkyl ether phosphate and the like) and the like can be enumerated. One of these discoloration inhibitors may be used individually, or two or more of them may be used arbitrarily in combination. The blending amount is preferably about 0.1-10 mass % based on the total amount of the composition.

As the surfactant, anionic surfactants, cationic surfactants, nonionic surfactants, amphoteric surfactants, and the like can be enumerated. As the anionic surfactant, alkylbenzene sulfonate, α-olefin sulfonate, and the like are included. As the cationic surfactant, quaternary ammonium salts such as alkyltrimethylammonium salt, dialkyldimethylammonium salt, alkyldimethylbenzylammonium salt, and the like are included. As the nonionic surfactant, ethers such as polyoxyethylene polyoxypropylene alkyl ether (for example, polyoxyethylene polyoxypropylene C12-14 alkyl ether), polyoxyalkylene alkyl ether, polyoxyethylene alkyl ether, polyoxyethylene alkyl phenyl ether, or esters such as sorbitan fatty acid ester, polyoxyethylene sorbitan fatty acid ester, polyoxyethylene fatty acid ester, amides such as fatty acid alkanolamides can be enumerated. As the amphoteric surfactant, alkylbetaines and the like as the betaine-based surfactant can be enumerated. One of these surfactants may be used individually, or two or more of them may be used arbitrarily in combination. The blending amount is preferably about 0.1-10 mass % based on the total amount of the composition.

As the metal deactivator, for example, benzotriazole, benzotriazole derivatives, imidazoline, pyrimidine derivatives, thiadiazole, thiadiazole derivatives, and the like can be enumerated. One of these metal deactivators may be used individually, or two or more of them may be used arbitrarily in combination. The blending amount is preferably about 0.01-10 mass % based on the total amount of the composition.

As the rust inhibitor, for example, dodecanedioic acid, amine salts of dodecanedioic acid, amine salts of nonanoic acid, alkyl benzenesulfonate ester, dinonyl naphthalenesulfonate ester, alkenyl succinates, polybasic alcohol esters and the like can be enumerated. One of these rust inhibitors may be used individually, or two or more of them may be used arbitrarily in combination. The blending amount is preferably about 0.1-30 mass % based on the total amount of the composition.

As the defoaming agent, for example, silicone-based defoaming agents and the like can be enumerated. One of these defoaming agents may be used individually, or two or more of them may be used arbitrarily in combination. The blending amount is preferably about 0.01 mass % or more and 1 mass % or less based on the total amount of the composition.

As the bactericide, for example, hydroxypyrithione-based bactericides, thiazoline-based preservatives, triazine-based preservatives, alkyl benzimidazole-based preservatives, p-hydroxy benzoates (Nipagin esters), benzoic acid, salicylic acid, sorbic acid, dehydroacetic acid, p-toluenesulfonic acid and salts thereof, phenoxyethanol, and the like can be enumerated. One of these bactericides may be used individually, or two or more of them may be used arbitrarily in combination. The blending amount is preferably about 0.01-5 mass % based on the total amount of the composition.

<Process for Preparing the Water-Soluble Metalworking Fluid Composition>

The process for preparing the water-soluble metalworking fluid composition of the present invention is to prepare a water-soluble metalworking fluid composition by blending the above-mentioned components (A), (B), and (C) in a manner of forming the following blending amounts,

the component (A) comprises 1-20 mass %, based on the total amount of the component (A), the component (B), and the component (C),

the component (B) comprises 30-60 mass %, based on the total amount of the component (A), the component (B), and the component (C),

the component (C) comprises 35-55 mass %, based on the total amount of the component (A), the component (B), and the component (C).

Further, in the preparation of the water-soluble metalworking fluid composition of the present invention (the stock solution), the above-mentioned component (D) and the above-mentioned other components can also be blended. Moreover, as the blending amount of the above-mentioned component (D), it is blended in a manner of forming the blending amount as described for the above-mentioned component (D). Moreover, as the blending amounts of the above-mentioned other components, they are blended in a manner of forming the blending amounts as described for the above-mentioned other components.

The process for preparing the water-soluble metalworking fluid composition of the present invention is a process for preparing the above-mentioned water-soluble metalworking fluid composition, and for each component, each component as described in the above-mentioned water-soluble metalworking fluid composition is blended. In addition, the blending amount of each component is in such a manner that the blending amount of each component as described in the above-mentioned water-soluble metalworking fluid composition is formed.

In the preparation of the water-soluble metalworking fluid composition of the present invention (the stock solution), water can also be further blended. By blending water, sometimes there may be an effect of increasing the dispersion stability of the composition or the liquid stability of the composition. There is no particular limitation on the water used in preparing the stock solution, and for example, deionized water (ion-exchanged water), pure water, tap water, industrial water, and the like can be used. The blending amount of the water for preparing the stock solution is 1-99 mass %, preferably 3-85 mass %, more preferably 6-75 mass %, further preferably 9-60 mass %, based on the total amount of the composition.

In one embodiment of the present invention, the blending amount of the water for preparing the stock solution is 10 mass %, 51.6 mass %, or 56.3 mass %, based on the total amount of the composition.

The dispersion stability of the composition or the liquid stability of the composition also varies depending on the above-mentioned components in the composition and blending ratios thereof. Therefore, there are cases where water is not required. In these cases, the water-soluble metalworking fluid composition of the present invention (the stock solution) only contains the above-mentioned components (A), (B), and (C), or only contains the above-mentioned components (A), (B), (C), and (D), or only contains the above-mentioned components (A), (B), and (C) and other components, or only contains the above-mentioned components (A), (B), (C), and (D) and other components.

In the preparation of the water-soluble metalworking fluid composition of the present invention (the stock solution), a base oil may also be further blended. As the base oil, a mineral oil, a synthetic oil, and an oil and fat can be enumerated. One of them may be used individually, or two or more of them may be used arbitrarily in combination.

As the mineral oil, a paraffin-based mineral oil, a naphthene-based mineral oil, an intermediate-based mineral oil and the like can be enumerated. As these mineral oils, more specifically, for example, an atmospheric residue obtained by subjecting the paraffin-based crude oil, the naphthene-based crude oil, the intermediate-based crude oil, and the like to atmospheric distillation; a distillate oil obtained by subjecting the atmospheric residue to vacuum distillation; a mineral oil purified by subjecting the distillate oil to one or more of treatments such as solvent deasphalting, solvent extraction, hydrocracking, solvent dewaxing, catalytic dewaxing, and hydrogenation purifying; and the like can be enumerated. The paraffin-based mineral oil is appropriate among the mineral oils. One of these mineral oils may be used individually, or two or more of them may be used arbitrarily in combination. In one embodiment of the present invention, the base oil in the water-soluble metalworking fluid composition of the present invention is a paraffin-based mineral oil.

In addition, as the mineral oil, it may be a substance classified into any one of Groups 1, 2, and 3 in the base oil types of API (American Petroleum Institute).

As the synthetic oil, for example, poly alpha-olefins, alpha-olefin copolymers, polybutenes, alkylbenzenes, polyoxyalkylene glycols, polyoxyalkylene glycol esters, polyoxyalkylene glycol ethers, silicone oils, polyol esters, monoesters, fatty acid esters, and alpha-olefins and the like, can be enumerated. Among the synthetic oils, fatty acid esters and monoesters are preferable, and fatty acid esters are more suitable. One of these synthetic oils may be used individually, or two or more of them may be used arbitrarily in combination.

As oils and fats, for example, natural oils and fats (for example, tallow, lard, soybean oil, rapeseed oil, rice bran oil, castor oil, coconut oil, palm oil, palm-kernel oil, and the like), hydrogenated products of the natural oils and fats, and the like can be enumerated. In addition, the oils and fats may be synthetic oils and fats such as esters. As the ester, for example, an ester obtained by the reaction of a carboxylic acid having a C6-C24 hydrocarbon group and a carboxyl group with a C1-C18 alcohol, and the like, can be enumerated. One of these oils and fats may be used individually, or two or more of them may be used arbitrarily in combination. In one embodiment of the present invention, the base oil in the water-soluble metalworking fluid composition of the present invention is methyl oleate.

In one embodiment of the present invention, the base oil in the water-soluble metalworking fluid composition of the present invention is a paraffin-based mineral oil and methyl oleate.

One of the above-mentioned base oils may be used individually, or two or more of them may be used arbitrarily in combination.

From the viewpoint of the lubricity, the above-mentioned base oil has a kinematic viscosity at 40° C. of 0.1 mm²/s or more, preferably 0.5 mm²/s or more, more preferably 1 mm²/s or more, further preferably 5 mm²/s or more. In addition, from the viewpoints of the operability of the stock solution and the permeability into a workpiece to be cut—a tool, the above-mentioned base oil has a kinematic viscosity at 40° C. of 150 mm²/s or less, preferably 100 mm²/s or less, more preferably 50 mm²/s or less, further preferably 10 mm²/s or less.

It should be noted that the kinematic viscosity is the value measured according to ASTM D445.

The blending amount of the above-mentioned base oil is 0.5 mass % or more, preferably 1 mass % or more, more preferably 5 mass % or more, particularly preferably 9 mass % or more, based on the total amount of the composition. On the other hand, the blending amount of the above-mentioned base oil is 65 mass % or less, preferably 60 mass % or less, more preferably 55 mass % or less, particularly preferably 50 mass % or less, based on the total amount of the composition. If the content of the above-mentioned base oil is 0.5 mass % or more, the effect of inhibiting the tool wear is further enhanced.

In one embodiment of the present invention, the blending amount of the above-mentioned base oil is 10 mass %, 15 mass %, or 48.6 mass %, based on the total amount of the composition.

[Water-Soluble Metalworking Oil]

For the water-soluble metalworking fluid composition of the present invention, the composition can be used as stock solution, and diluted with water according to its use object in a manner for forming an appropriate concentration; the diluted solution, as the water-soluble metalworking oil (hereinafter also referred to as “diluted solution”), is suitably used in various metalworking fields such as grinding, stretching, drawing and pulling, rolling and the like, preferably punching machining, cutting machining, and grinding machining. It should be noted that as the grinding machining, cylinder grinding machining, inner surface grinding machining, plane grinding machining, hollowness grinding machining, tool grinding machining, honing finish, superfinish, and special curve grinding machining (e.g., screw grinding, gear grinding, cam grinding, and roll grinding) and the like can be enumerated. It should be noted that the water-soluble metalworking fluid composition of the present invention, according to its use object, can be used without dilution; and in this situation, the water-soluble metalworking fluid composition becomes a water-soluble metalworking oil.

[Use of the Water-Soluble Metalworking Fluid Composition, and Method of Using the Water-Soluble Metalworking Fluid Composition]

The water-soluble metalworking fluid composition of the present invention is suitable for the punching machining, the cutting machining, or the grinding machining.

The water-soluble metalworking fluid composition of the present invention is diluted with water so that in the use, the concentration of the water-soluble metalworking fluid composition is preferably 3 vol % or more, while in the metalworking use, the concentration is more preferably 5 vol % or more, further preferably 10 vol % or more. If the concentration at the time of dilution with water is 3 vol % or more, the effect of the reduced tool wear can be sufficiently obtained, and the effect of the extended tool life can be sufficiently obtained. On the other hand, it is preferable to dilute with water so that in the use, the concentration of the water-soluble metalworking fluid composition is 100 vol % or less, while in the metalworking use, the concentration is more preferably 80 vol % or less, and further preferably 50 vol % or less.

Among others, for the water-soluble metalworking fluid composition of the present invention, regardless of whether it is a stock solution or a diluted solution, it is not necessary that all of the blended components are uniformly dissolved. Therefore, it may be in form of a solution, in form of being soluble, or in a dispersed form, such as in form of an emulsion.

It should be noted that for the water used for diluting the stock solution, for example, deionized water (ion-exchanged water), pure water, tap water, industrial water, and the like can be used.

The water-soluble metalworking fluid composition of the present invention is preferably used in the machining of the material such as iron-based materials (for example, carbon steel, cast iron, stainless steel, alloy steel, and the like), or nickel-based alloys (for example, Inconel alloys, and heat-resistant and corrosion-resistant nickel-based alloys, and the like). If the water-soluble metalworking fluid composition of the present invention with a strong effect of inhibiting the tool wear is used in the machining of the above-mentioned materials to be machined, various tools can be used for the machining.

### Examples

Hereinafter, the present invention will be described in more detail with reference to Examples and Comparative Examples, but the present invention is not limited by these disclosure contents at all. It should be noted that the properties and the characteristics of the compositions in examples are obtained with the following methods.

(1) Kinematic Viscosity

The kinematic viscosity at 40° C. was determined according to ASTM D445.

(2) Acid Value

Determined according to ASTM D664.

(3) Iodine Value

Determined according to ASTM D 1959.

<Evaluation of the Composition>

The compositions for evaluation were prepared with the blending compositions shown in Table 1.

The evaluation of each composition was performed with the following method. The obtained results were shown in Table 2.

Evaluation Items

(1) Fouling (Cylinder Oscillation Method)
In a 100 mL measuring cylinder with a stopper, 5 g of aluminum powder and 5 g of iron powder were added to 100 mL of the diluted solution (5 vol % of stock solution). ※ Aluminum powder and iron powder were reagents.
The cylinder was strongly shaken by hand for 10 seconds and then allowed to stand by itself.
The appearance after 30 seconds of standing was observed (the left photograph in each figure, which was recorded as “oscillation ended”).
After standing for 10 minutes, the measuring cylinder was inverted several times and allowed to stand again, and the appearance after 30 seconds of standing was observed (the right photograph in each figure, which was recorded as “standing for 10 minutes”).
Fouling baseline.

After the oscillation, it was allowed to stand, and the evaluation was performed on whether or not a fouling remained on the liquid surface.

∘; No fouling remained on the liquid surface after standing

Δ; A little fouling remained on the liquid surface after standing

x; A considerable amount of fouling remained on the liquid surface after standing.

(2) Workability (Tapping Torque Test)

The evaluation of the workability was performed with the tapping torque test method. Specific conditions were described in examples.

TABLE 1

| | | | Comp. | | Comp. | | Comp. |
|---|---|---|---|---|---|---|---|
| Category | Component | Ex. 1 | Ex 1 | Ex. 2 | Ex. 2 | Ex. 3 | Ex. 3 |
| Water | Ion-exchange water | 51.6 | 49.8 | 56.3 | 48.4 | 10 | 10.3 |
| Water-soluble | Mono-isopropanolamine | 4 | 4 | 3.5 | 3 | 2.5 | 2.5 |
| amine | (1-amino-2-propanol) | | | | | | |
| | Triethanolamine | 2.3 | 2.3 | 5 | 6 | 9 | 2 |
| | N-methyldiethanolamine | 5.4 | 5.4 | 2.8 | 2.8 | 3.4 | 3.4 |
| Nonionic | Polyoxyethylene polyoxypropylene | 0.9 | 0.9 | 1 | 1.7 | 2 | 2 |
| surfactant | C12-14alkyl ether (HLB 12.7) | | | | | | |
| Component (A) | Neo-decanoic acid | 1.5 | 4.1 | 1.5 | 4.4 | 1.7 | 5.2 |
| | (acid value: 320 mgKOH/g) | | | | | | |
| Corrosion inhibitor | 1,2,3-benzotriazole | 0.5 | 0.3 | 0.5 | 0.5 | 1 | 1 |
| Dibasic acid | Dodecanedioic acid | 1 | 0.9 | 1 | 1.5 | 1.5 | 1.5 |
| Non water- | Dicyclohexyl amine | 4 | 2.4 | 4 | 4 | 7 | 7 |
| soluble amine | | | | | | | |
| Component (B) | Rice bran oil fatty acid (Acid value: | 7 | 1.6 | 7 | 3.3 | 8.4 | 2.7 |
| | 197 mgKOH/g, containing 80% or more of | | | | | | |
| | an unsaturated fatty acid having a carbon | | | | | | |
| | atom number of 18, Iodine value: 118-132) | | | | | | |
| Component (C) | Polyricinoleic acid (having an acid value | 6.5 | 9.4 | 6.5 | 13.3 | 11 | 15.7 |
| | of 35 mgKOH/g, and a polymerization | | | | | | |
| | degree of 6). | | | | | | |
| Discoloration | Phosphate ester-based corrosion inhibitor | — | 0.4 | 0.6 | 0.8 | 0.6 | 0.6 |
| inhibitor | | | | | | | |
| Base oil | Paraffin-based mineral oil (kinematic | 15 | 18.2 | 10 | 10 | 38.8 | 45.8 |
| | viscosity at 40° C.: 7.117 mm²/s) | | | | | | |
| | Methyl oleate | — | — | — | — | 9.8 | — |
| Bactericide | Thiazoline-based preservative | 0.1 | 0.1 | 0.1 | 0.1 | 0.1 | 0.1 |
| | Hydroxypyrithione-based bactericides | 0.1 | 0.1 | 0.1 | 0.1 | 0.1 | 0.1 |
| Defoaming agent | Silicone-based defoaming agent | 0.1 | 0.1 | 0.1 | 0.1 | 0.1 | 0.1 |
| | Total | 100 | 100 | 100 | 100 | 100 | 100 |

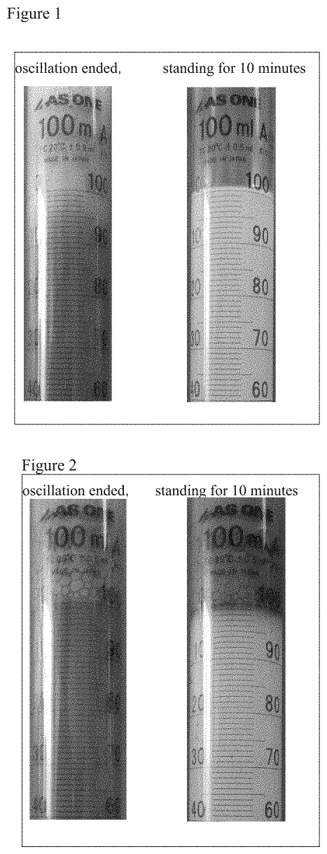

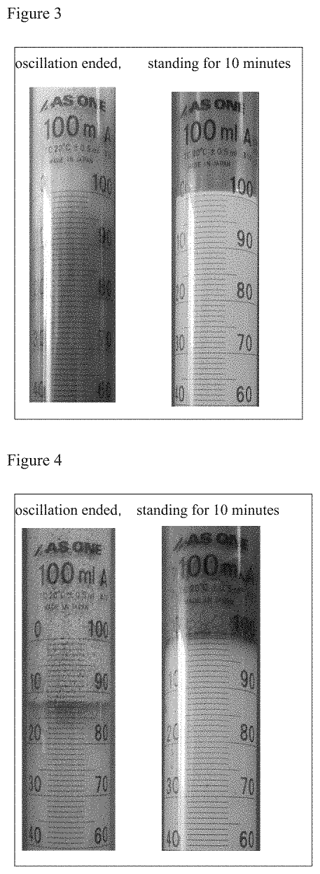

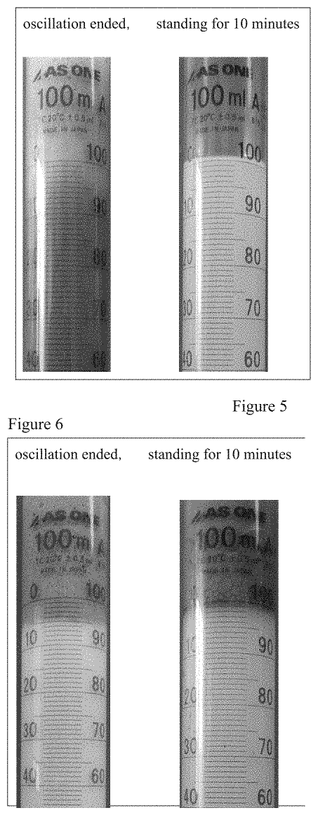

TABLE 2

| | | | Comp. | | Comp. | | Comp. |
|---|---|---|---|---|---|---|---|
| | Content | Ex. 1 | Ex. 1 | Ex. 2 | Ex. 2 | Ex. 3 | Ex. 3 |
| Evaluation | Workability (N · cm) | 212.3 ※1 | Impossible | 103.7 ※2 | 163.7 ※2 | 76.7 ※3 | 95.3 ※3 |
| | | | to measure the | | | | |
| | | | workability | | | | |
| | | | due to the poor | | | | |
| | | | workability ※1 | | | | |
| | Fouling (detergency) | See | See | See | See | See | See |
| | | FIG. 1 | FIG. 2 | FIG. 3 | FIG. 4 | FIG. 5 | FIG. 6 |
| | | ∘ | x | ∘ | x | ∘ | x |
| | A/(A + B + C) | 10.0% | 27.2% | 10.0% | 21.0% | 8.1% | 22.0% |
| | B/(A + B + C) | 46.7% | 10.6% | 46.7% | 15.7% | 39.8% | 11.4% |
| | C/(A + B + C) | 43.3% | 62.3% | 43.3% | 63.3% | 52.1% | 66.5% |
| | A(acid value × blending amount)/ | 0.3481 | 4.1624 | 0.3481 | 2.1658 | 0.3287 | 3.1284 |
| | B(acid value × blending amount) | | | | | | |
| | A(acid value × blending amount)/ | 2.1099 | 3.9878 | 2.1099 | 3.0247 | 1.4130 | 3.0282 |
| | C(acid value × blending amount) | | | | | | |
| | B(acid value × blending amount)/ | 6.0615 | 0.9581 | 6.0615 | 1.3966 | 4.2982 | 0.9680 |
| | C(acid value × blending amount) | | | | | | |
| | A/B(blending ratio) | 0.214 | 2.563 | 0.214 | 1.333 | 0.202 | 1.926 |
| | A/C(blending ratio) | 0.231 | 0.436 | 0.231 | 0.331 | 0.155 | 0.331 |
| | B/C(blending ratio) | 1.077 | 0.170 | 1.077 | 0.248 | 0.764 | 0.172 |

※1 Tapping torque test
Tester: Megatap II (micro-electronische Gerate GmbH)
Tool: TTT T-M4C-T 3.625 mm
Test conditions: depth = 20 mm, velocity = 600 rpm, torque = 400 Ncm
Material to be cut: stainless steel (JIS SUS316Ti)
Dilution ratio: 5 vol % (diluted with water).
※2 Tapping torque test
Tester: Megatap II (micro-electronische Gerate GmbH)
Tool: TTT T-M4F-NT 3.625 mm
Test conditions: depth = 20 mm, velocity = 1000 rpm, torque = 400 Ncm
Material to be cut: aluminum alloy (JIS A7075)
Dilution ratio: 5 vol % (diluted with water).
※3 Tapping torque test
Tester: Megatap II (micro-electronische Gerate GmbH)
Tool: TTT T-M4F-NT 3.625 mm
Test conditions: depth = 20 mm, velocity = 1000 rpm, torque = 400 Ncm
Material to be cut: aluminum alloy (JIS A7075)
Dilution ratio: 5 vol % (diluted with water).

It should be noted that, in Table 2, “A/(A+B+C)” represented the ratio of the blending amount of the component (A) based on the total amount of the component (A), the component (B), and the component (C). “B/(A+B+C)” represented the ratio of the blending amount of the component (B) based on the total amount of the component (A), the component (B), and the component (C). “C/(A+B+C)” represented the ratio of the blending amount of the component (C) based on the total amount of the component (A), the component (B), and the component (C). “A/B” represented the blending ratio of the component (A) to the component (B) based on the total amount of the composition. “A/C” represented the blending ratio of the component (A) to the component (C) based on the total amount of the composition. “B/C” represented the blending ratio of the component (B) to the component (C) based on the total amount of the composition.

According to the results of the above-mentioned examples and comparative examples, the water-soluble metalworking fluid composition of the present application could maintain the workability while improving the mechanical fouling.

1. A water-soluble metalworking fluid composition, comprising the following components (A), (B), and (C), based on a total amount of (A), (B), and (C):
(A) 1-20 mass % of a fatty acid having a carbon atom number of 9-11;
(B) 30-60 mass % of an unsaturated fatty acid having a carbon atom number of 16-22; and
(C) 35-55 mass % of a polymeric fatty acid having an acid value of 10-200 mgKOH/g.

2. The composition according to claim 1, wherein the composition does not contain a hydroxy aliphatic carboxylic acid having a carbon atom number of 2-8.

3. The composition according to claim 1, wherein a ratio of an (acid value×blending amount) of (A) to an (acid value×blending amount) of (B) is 0.01-2, wherein the blending amount of (A) and the blending amount of (B) are based on a total amount of the composition.

4. The composition according to claim 1, wherein a ratio of a blending amount of (A) to a blending amount of (B) on a mass basis is 0.01-1, wherein the blending amount of (A) and the blending amount of (B) are based on a total amount of the composition.

5. The composition according to claim 1, wherein a total content of (A), (B), and (C) in the composition is 7 mass % or more based on a total amount of the composition.

6. The composition according to claim 1, wherein a constituting unit of the polymeric fatty acid of (C) is a hydroxy fatty acid.

7. The composition according to claim 1, wherein (C) has a weight-average molecular weight of 400-4000.

8. The composition according to claim 1, further comprising an amine compound as a component (D).

9. A method for punching machining, cutting machining, and grinding machining, comprising:
processing a metal material by using the composition according to claim 1.

10. The composition according to claim 1, wherein a blending amount of (A) is 0.05-4 mass % based on a total amount of the composition.

11. The composition according to claim 1, wherein a blending amount of (B) is 3-10 mass % based on a total amount of the composition.

12. The composition according to claim 1, wherein a blending amount of (C) is 4-16 mass % based on a total amount of the composition.

13. The composition according to claim 1, further comprising at least one of a corrosion inhibitor, a discoloration inhibitor, a surfactant, a metal deactivator, a rust inhibitor, a defoaming agent, or a bactericide.

14. A method of applying a water-soluble metalworking fluid composition, comprising:
diluting the composition according to claim 1 with water such that a concentration of the composition is 3 vol % or more.

15. A method for metalworking, comprising:
processing a metal material by using the composition according to claim 1.

16. A method of preparing a water-soluble metalworking fluid composition, comprising blending the following components (A), (B), and (C), wherein the components are based on a total amount of (A), (B), and C:
(A) 1-20 mass % of a fatty acid having a carbon atom number of 9-11;
(B) 30-60 mass % of an unsaturated fatty acid having a carbon atom number of 16-22; and
(C) 35-55 mass % of a polymeric fatty acid having an acid value of 10-200 mgKOH/g.

17. A water-soluble metalworking fluid composition prepared by the method according to claim 16.
